(19) United States
(12) Patent Application Publication
(10) Pub. No.: US 2018/0263255 A1
(43) Pub. Date: Sep. 20, 2018

(54) EDIBLE BUILDING SYSTEMS AND METHODS OF USING

(71) Applicant: David Homer Mays, Salt Lake City, UT (US)

(72) Inventor: David Homer Mays, Salt Lake City, UT (US)

(21) Appl. No.: 15/920,302

(22) Filed: Mar. 13, 2018

Related U.S. Application Data
(60) Provisional application No. 62/471,233, filed on Mar. 14, 2017.

(51) Int. Cl. A23G 3/34; A21D 13/47

(52) U.S. Cl. CPC A23G 3/343; A23V 2002/00; A21D 13/47

(57) ABSTRACT

Edible building systems and edible connectors for constructing gingerbread-style houses are disclosed. The edible connectors are configured to interconnect edible panels to construct the gingerbread-style houses. The edible connectors include a body and a cutout portion configured to receive an edge of an edible panel. The cutout portion includes slots that can be oriented at 90° or 180° with respect to each other. The cutout portion can include retaining ridges, retaining bumps, and texturing to retain and secure the edge of the edible panel.

### BACKGROUND

This disclosure pertains to edible building systems and methods of using edible building systems. More particularly, some implementations of the present disclosure relate to edible connectors configured to interconnect edible panels for the construction of model houses. These edible connectors can be used to interconnect edible panels for the construction of model gingerbread-style houses.

Gingerbread-style houses are edible decorative model houses that are constructed from baked gingerbread biscuit panels and other similar materials. Gingerbread-style houses are popular during the winter holidays and comprise edible baked panels interconnected into a model house shape. The gingerbread-style houses can also be further decorated with a variety of candies and icing. Traditionally, the edible panels comprise sheets of baked gingerbread cookie or biscuit that are shaped into the various pieces of the gingerbread-style house. Additionally, commercially prepared crackers or biscuits, such as graham crackers, are often used as the edible baked panels in the construction of gingerbread-style houses. Commercially prepared crackers or biscuits, such as graham crackers can be a convenient and/or time-saving option, especially for children.

In conventional assembly, the edible baked panels are arranged by hand and then secured to one another with an adhesive such as royal icing. The edible baked panels are secured once the adhesive such as royal icing sets. A feature of royal icing is that the icing is edible along with the edible baked panels and other candy decorations. Of course, other non-edible adhesives such as glue and/or hot glue (e.g., hot melt adhesive, thermoplastic adhesive, and other similar adhesives) can also be used.

Conventional methods and systems of securing the edible panels with icing can suffer from a number of drawbacks. For example, during assembly, the edible panels must be held by hand or otherwise secured in place until the icing sets. This can require a steady hand and some patience and can be frustrating, especially for younger children. Waiting for the icing to set can also be time consuming. Also, the application of the icing can be messy and can lead to wasted icing and additional clean-up. Likewise, the use of an adhesive such as hot glue also possesses a number of drawbacks. Burns can result from contact with the hot glue and/or the glue gun and can be especially dangerous for younger children. Similarly, excess hot glue can drip onto other portions of the gingerbread-style house, clothing, tables, and/or dishes, staining and/or ruining these items. Lastly, using glue or hot glue results in a model that is no longer edible, at least in part, thereby removing the novelty of creating a gingerbread-style house that is completely edible.

Thus, while there are some options for interconnecting edible panels for construction of gingerbread-style houses, challenges still exist, including those listed above. Accordingly, it would be an improvement in the art to augment or even replace conventional methods and compositions with other methods and compositions.

### BRIEF SUMMARY

Described herein are some embodiments of methods and systems for interconnecting edible panels for construction of gingerbread-style houses. In some embodiments, the edible connector comprises a body comprising an edible material and a cutout portion disposed on the body, with the cutout portion configured to receive and secure an edge of an edible panel. In some cases, the cutout portion can comprise a first slot. In other cases, the first slot can comprise a channel floor and channel walls. In yet other cases, the cutout portion can comprise a second slot. In some instances, the second slot can comprise a channel floor and channel walls. In other instances, the first slot can be oriented at 90° with respect to the second slot. In yet other instances, the first slot can be oriented at 180° with respect to the second slot.

In some embodiments, the edible connector comprises a hard candy. In some cases, the hard candy can comprise a sugar glass candy prepared by heating a sugar-based syrup to between about 146° C. and 154° C. to achieve a hard crack stage. In other cases, the cutout portion can comprise one or more of a retaining ridge, a retaining bump, and a texturing configured to retain the edge of the edible panel. In yet other cases, the first slot and second slot can comprise retaining ridges disposed on the channel walls and rising from the channel floor. In some instances, the retaining ridges can be chamfered as they meet the channel walls.

In some embodiments, the edible building system for constructing gingerbread-style houses comprises edible connectors comprising a body with a cutout portion, the cutout portion configured to receive and secure an edge of an edible panel and edible panels with the edible connectors configured to interconnect the edible panels to construct a gingerbread-style house. In other embodiments, wherein the cutout portion further comprises a first slot and a second slot. In some cases, the first slot can be oriented at 90° with respect to the second slot. In other cases, the first slot can be oriented at 180° with respect to the second slot.

In some embodiments, the edible connectors comprise a hard candy. In other embodiments, the cutout portion further comprises one or more of a retaining ridge, a retaining bump, and a texturing configured to retain the edge of the edible panel. In yet other embodiments, the first slot and second slot comprise retaining ridges disposed on channel walls and rising from a channel floor. In some cases, the retaining ridges are chamfered as they meet the channel walls.

In some embodiments, a method of manufacturing an edible connector configured to interconnect edible panels for the construction of gingerbread-style houses comprises providing a mold to form an edible connector comprising a body with a cutout portion disposed on the body, wherein the cutout portion is configured to receive and secure an edge of an edible panel, preparing a hard candy comprising a sugar glass candy prepared by heating a sugar-based syrup to between about 146° C. and 154° C. to achieve a hard crack stage, and molding the prepared hard candy with the mold. In some cases, the cutout portion can comprise a first slot and a second slot. In other cases, the first slot can be oriented at 90° with respect to the second slot. In yet other cases, the first slot can be oriented at 180° with respect to the second slot. In some instances, the cutout portion can further comprise one or more of a retaining ridge, a retaining bump, and a texturing configured to retain the edge of the edible panel. In other instances, the first slot and second slot can comprise retaining ridges disposed on channel walls and rising from a channel floor. In yet other instances, the retaining ridges can be chamfered as they meet the channel walls.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1A illustrates an isometric view of some embodiments of an edible connector comprising slots;

FIG. 1B illustrates an isometric view of some embodiments of an edible connector comprising slots;

FIG. 1C illustrates a top view of some embodiments of an edible connector comprising slots;

FIG. 2A illustrates an isometric view of some embodiments of an edible connector comprising slots with a retaining ridge;

FIG. 2B illustrates an isometric view of some embodiments of an edible connector comprising slots with a retaining ridge;

FIG. 2C illustrates a top view of some embodiments of an edible connector comprising slots with a retaining ridge;

FIG. 2D illustrates embodiments of an end view of some embodiments of an edible connector comprising slots with a retaining ridge;

FIG. 3A illustrates an isometric view of some embodiments of an edible connector comprising slots with retaining bumps;

FIG. 3B illustrates an isometric view of some embodiments of an edible connector comprising slots with retaining bumps;

FIG. 3C illustrates a top view of some embodiments of an edible connector comprising slots with retaining bumps;

FIG. 3D illustrates embodiments of an end view of some embodiments of an edible connector comprising slots with retaining bumps;

FIG. 4A illustrates an isometric view of some embodiments of an edible connector comprising slots with texturing;

FIG. 4B illustrates an isometric view of some embodiments of an edible connector comprising slots with texturing;

FIG. 5A illustrates an isometric view of some embodiments of an edible connector comprising slots;

FIG. 5B illustrates an isometric view of some embodiments of an edible connector comprising slots;

FIG. 6A illustrates an isometric view of some embodiments of an edible connector comprising slots with a channel floor and channel walls;

FIG. 6B illustrates an isometric view of some embodiments of an edible connector comprising slots with a channel floor and channel walls;

FIG. 7A illustrates an isometric view of some embodiments of an edible connector comprising slots with a channel floor and channel walls;

FIG. 7B illustrates an isometric view of some embodiments of an edible connector comprising slots with a channel floor and channel walls;

FIG. 8A illustrates an isometric view of some embodiments of an edible connector comprising slots with a channel floor and channel walls with retaining ridges rising from the channel floor along the channel walls;

FIG. 8B illustrates an isometric view of some embodiments of an edible connector comprising slots with a channel floor and channel walls with retaining ridges rising from the channel floor along the channel walls;

FIG. 9A illustrates an isometric view of some embodiments of an edible connector comprising slots with a channel floor and channel walls with chamfered retaining ridges rising from the channel floor along the channel walls;

FIG. 9B illustrates an isometric view of some embodiments of an edible connector comprising slots with a channel floor and channel walls with chamfered retaining ridges rising from the channel floor along the channel walls;

FIG. 10 illustrates embodiments of edible connectors interconnecting edible panels at 90° angles;

FIG. 11 illustrates embodiments of edible connectors interconnecting edible panels at 180° angles;

FIG. 12 illustrates embodiments of edible connectors interconnecting edible panels at 90° angles; and

FIG. 13 illustrates embodiments of edible connectors interconnecting edible panels at 180° angles.

### DETAILED DESCRIPTION

The present disclosure relates to edible building systems and methods of using these edible building systems. More particularly, some embodiments of the present disclosure relate to edible connectors configured to selectively and reversibly interconnect edible panels for the construction of gingerbread-style houses. While these edible connectors can comprise any suitable component and/or ingredient, in some cases, these edible connectors comprise a candy confectionery.

In the present disclosure and in the claims, the term “gingerbread-style house” (and variations thereof) can be used to refer to edible decorative model houses that are constructed from baked gingerbread biscuit and/or cake panels and/or other similar materials. Gingerbread-style houses can include traditional model houses constructed during the winter holidays and comprising edible panels comprising baked gingerbread biscuit and/or cake panels. Gingerbread-style houses can also comprise other model structures including, but not limited to, houses, cottages, castles, churches, public buildings, town halls, villages, hotels, towers, ships, pirate ships, boats, and trains.

In some embodiments, the term “edible panel” refers to an edible panel that is configured to be used in the construction of a gingerbread-style house. Edible panels can comprise gingerbread including baked crisp ginger biscuit. Edible panels can also comprise graham-style crackers or graham wafers including commercially prepared graham crackers such as those sold under the HONEY MAID trademark. In some cases, edible panels can comprise other crackers and/or cookies such as shortbread cookies, cheese crackers, shredded wheat crackers, rice crackers, saltine crackers, soda crackers, toasted sandwich bread, and other similar crackers and/or cookies.

In some embodiments, the term “edible connector” can include any edible mechanical connector configured to selectively and reversibly interconnect and/or secure one or more edible panels for construction of a gingerbread-style house. Edible connectors can also include edible fasteners configured to selectively and reversibly interconnect and/or secure one or more edible panels for construction of a gingerbread-style house. In some cases, edible connectors can be configured to selectively and reversibly interconnect one or more edible panels to one another. In other cases, edible connectors can be configured to selectively and reversibly secure one or more edible panels to one another. In yet other cases, edible connectors can be configured to selectively and reversibly secure one or more edible panels to a base (e.g., a plate, a platter, and/or a cardboard panel).

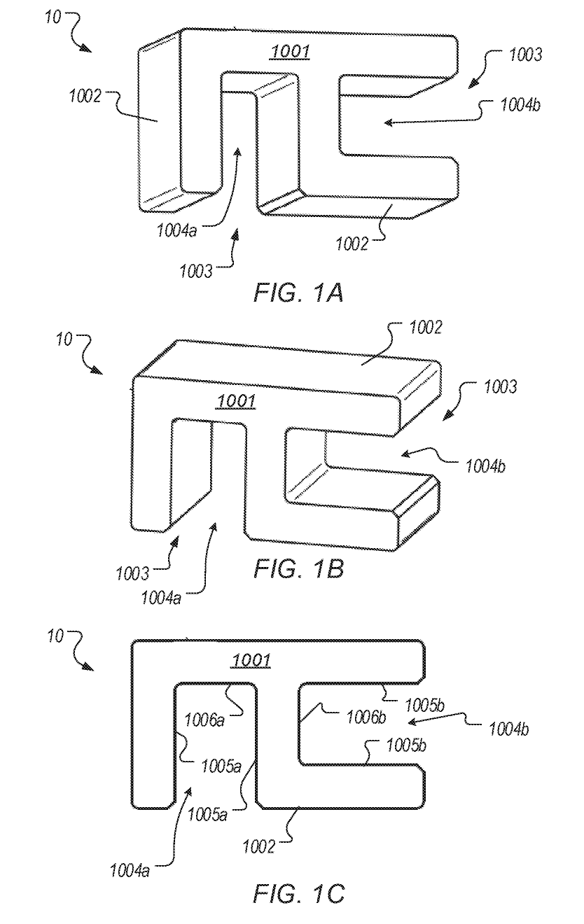

In general, and as mentioned above, some embodiments of the described systems and methods relate to edible connectors configured to selectively and reversibly interconnect and/or secure edible panels for the construction of gingerbread-style houses. While the described edible connector can comprise any suitable component or characteristic, FIGS. 1A, 1B, and 1C show that at least in some embodiments, an edible connector 10 comprises a body 1001. The body 1001 can be configured in any suitable manner that allows it to function as described. For example, the body 1001 can comprise an outer surface 1002. The outer surface 1002 of the body 1001 can be rounded, chamfered, and/or squared. Likewise, the outer surface 1002 can be textured and/or can display a decorative surface. In some cases, the outer surface 1002 can be textured to facilitate gripping and/or manipulation of the edible connector 10 by a user. In other cases, the outer surface 1002 can comprise decorative features to enhance the appearance of the completed gingerbreadstyle house. Additionally, the body 1001 can be configured to be sized to gripped and/or manipulated by the user. For example, the body 1001 can be configured to be sized to be gripped and/or manipulated by a thumb and forefinger of the user. Similarly, the body 1001 can be configured to be sized to be gripped and/or manipulated by a thumb and forefinger of a user that is a young child. In some instances, the body 1001 is configured as a rectangular block comprising one or more of a length, a width, and a height.

In some cases, the body 1001 can be configured with one or more cutout portions 1003. While the cutout portions 1003 can be configured in any suitable manner, at least in some embodiments, the cutout portions 1003 are configured to selectively and reversibly receive one or more edges of an edible panel. For example, the cutout portions 1003 can be configured as slots, channels, openings, grooves, canals, depressions, and/or other similar mechanical features. In some cases, the cutout portions 1003 can comprise a first slot 1004a and a second slot 1004b. The cutout portions 1003 (and likewise the first slot 1004a and the second slot 1004b) can be configured in any fashion with respect to each other. For example, as shown in FIGS. 1A, 1B, and 1C, the first slot 1004a and the second slot 1004b can be configured such that the slots are coplanar and arranged at an angle of approximately 90°. In some instances, the first slot 1004a and the second slot 1004b can be configured such that the slots are coplanar and arranged at an angle of approximately 90° to provide a selective and reversibly 90° connection between edible panels.

In some cases, the first slot 1004a and the second slot 1004b can be configured such that the slots are coplanar and arranged at an angle of between approximately 1° and 180°. In other cases, the first slot 1004a and the second slot 1004b can be configured such that the slots are coplanar and arranged at an angle of approximately 5°, 10°, 15°, 20°, 25°, 30°, 35°, 40°, 45°, 50°, 55°, 60°, 65°, 70°, 75°, 80°, 85°, 90°, 95°, 100°, 105°, 110°, 115°, 120°, 125°, 130°, 135°, 140°, 145°, 150°, 155°, 160°, 165°, 170°, 175° or 180°. In yet other cases, the first slot 1004a and the second slot 1004b can be configured such that the slots are not coplanar and are arranged at an angle of between approximately 1° and 180° in a first axis, between approximately 1° and 180° in a second axis, and between approximately 1° and 180° in a third axis.

As shown in FIG. 1C, in some embodiments, the cutout portions 1003 comprise the first slot 1004a and the second slot 1004b with each slot configured as coplanar rectangular channels. The first slot 1004a can comprise parallel channel walls 1005a oriented in perpendicular fashion to a channel floor 1006a. The second slot 1004b can likewise comprise parallel channel walls 1005b oriented in a perpendicular fashion to a channel floor 1006b. As shown in FIG. 1C, in some cases, one of the channel walls 1005b of the second slot 1004b can be oriented co-linearly with the channel floor 1006a of the first slot 1004a. In other cases, the cutout portions 1003 can be configured with one or more of chamfering, rounding, squaring, and texture. For example, FIGS. 1A, 1B, and 1C, illustrate the first slot 1004a and the second slot 1004b comprising rounding as the channel walls 1005a, 1005b join with the outer surface 1002. Likewise, the first slot 1004a and the second slot 1004b can comprising rounding as the channel walls 1005a, 1005b join with the channel floor 1006a, 1006b. In some instances, the first slot 1004a and the second slot 1004b can be configured to selectively and reversibly secure an edible panel by a friction fitting. In some embodiments, the cutout portion(s) 1003, such as slots 1004a and/or 1004b, have dimensions selected to receive and/or retain a panel such as an edible panel discussed herein. In some embodiments, the cutout portions 1003 may have an opening width, such as a space between the opposing walls, (such as channel walls 1005a or 1005b), which may be varied within the scope of the invention. In some embodiments, it may be from about 3 mm to about 9 mm, from about 4 mm to about 8 mm, from about 5 mm to about 7 mm, or in some embodiments, about 6 mm. The cutout portion(s) 1003, such as slots 1004a and/or 1004b, may also have a depth, such as a distance from the top of the cutout portion 1003 to the channel floor 1006a which may be varied within the scope of the invention. In some embodiments, this depth may be from about 6 mm to about 12 mm, from about 7 mm to about 11 mm, from about 8 mm to about 10 mm, or in some embodiments, about 9.8 mm. The cutout portion(s) 1003 may also have a length which may be varied within the scope of the invention. In some embodiments, the length of the cutout portion(s) 1003 may be as long as or longer than the length of the panels to be accommodated. In others, the length of the cutout portion(s) 1003 may be less than the length of the panels. In still others, the length of the cutout portion(s) could be at least about half the length of the panels to be accommodated. In others, length of the cutout portion(s) could be less than about half the length of the panels to be accommodated. In still others, the length of the cutout portion(s) could be from about 7 mm to about 130 mm, from about 7 mm to about 65 mm, or from about 7 mm to about 11 mm in length. These dimensions may be varied to better accommodate the panels to be accommodated.

Additionally, in some embodiments, the cutout portions 1003 comprise features configured to selectively and reversibly secure and/or retain the edible panels. For example, the cutout portions 1003 can comprise one or more of friction fittings, grips, gripping teeth, ridges, fins, bumps, texturing, pins, and other similar features.

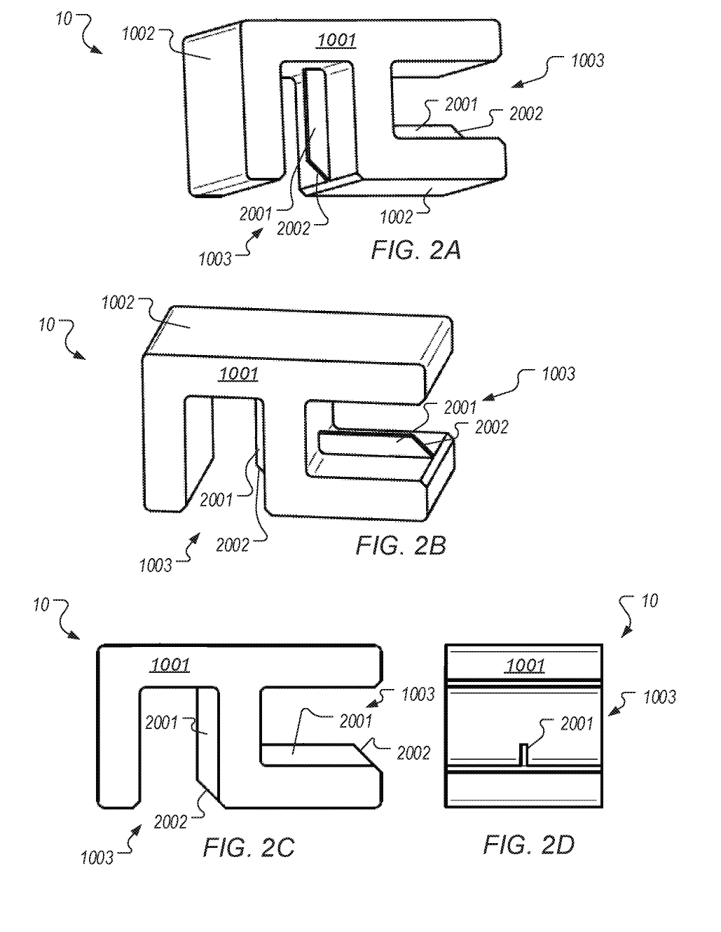

Referring now to FIGS. 2A, 2B, 2C, and 2D, some embodiments of an edible connector 10 comprising features configured to selectively and reversibly secure and/or retain the edible panels are illustrated. FIGS. 2A, 2B, 2C, and 2D show that at least in some embodiments, the edible connector 10 comprises one or more retaining ridges 2001 configured to selectively and reversibly secure and/or retain the edge of an edible panel once the edge has been inserted into the cutout portion 1003. Although the retaining ridges 2001 can be configured in any suitable manner, at least in some instances the retaining ridges 2001 can be configured as narrow ridges rising from the cutout portion 1003. For example, the retaining ridges 2001 can be configured to rise from a parallel channel wall 1005a, 1005b. In some cases, the retaining ridges 2001 can be configured to indent into, at least in part, the edible panel once the edge of the edible panel is inserted into the cutout portion 1003, thereby selectively and reversibly securing the edible panel into the cutout portion 1003 and avoiding disengagement of the edible panel from the edible connector 10. In other cases, the retaining ridges 2001 can be configured to indent into, at least in part, the edible panel once the edge of the edible panel is inserted into the cutout portion 1003, thereby selectively and reversibly securing the edible panel into the cutout portion 1003 by friction. In yet other cases, the retaining ridges 2001 can be configured and/or sized to indent into the edible panel without cracking or breaking the edible panel and/or the edible connector 10.

In some instances, the retaining ridges 2001 can be configured with a chamfered leading edge 2002. The chamfered leading edge 2002 can ease insertion of the edge of the edible panel into the cutout portion 1003. In other instances, the retaining ridges 2001 can comprise one or more of a squared, a rounded, a sloped, a beveled, and a tapered leading edge. Although FIGS. 2A, 2B, 2C, and 2D illustrate only one retaining ridge 2001 per cutout portion 1003, a cutout portion 1003 can comprise more than one retaining ridge 2001. For example, a cutout portion 1003 can comprise 1, 2, 3, 4, 5, 6, 7, 8, 9, 10 or more retaining ridges 2001.

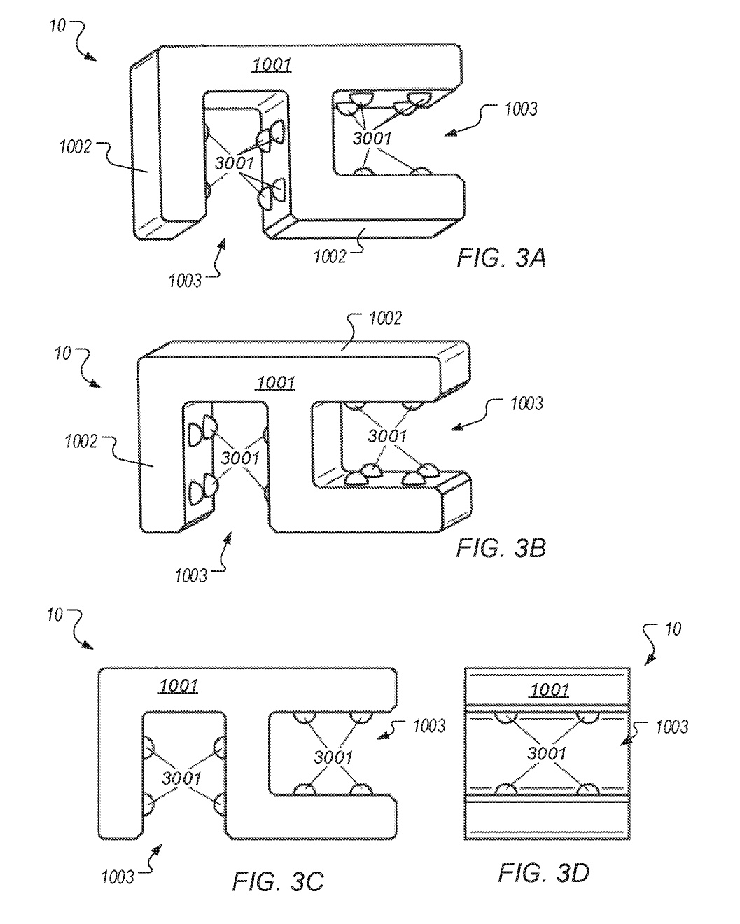

Referring now to FIGS. 3A, 3B, 3C, and 3D, some embodiments of an edible connector 10 comprising features configured to selectively and reversibly secure and/or retain the edible panels are illustrated. FIGS. 3A, 3B, 3C, and 3D show that at least in some embodiments, the edible connector 10 comprises one or more retaining bumps 3001 configured to selectively and reversibly secure and/or retain the edge of an edible panel once the edge has been inserted into the cutout portion 1003. Although the retaining bumps 3001 can be configured in any suitable manner, at least in some instances the retaining bumps 3001 can be configured as rounded hemispheres rising from the cutout portion 1003. For example, the retaining bumps 3001 can be configured to rise from a parallel channel wall 1005a, 1005b. In some cases, the retaining bumps 3001 can be configured to indent into, at least in part, the edible panel once the edge of the edible panel is inserted into the cutout portion 1003, thereby selectively and reversibly securing the edible panel into the cutout portion 1003 and avoiding disengagement of the edible panel from the edible connector 10. In other cases, the retaining bumps 3001 can be configured to indent into, at least in part, the edible panel once the edge of the edible panel is inserted into the cutout portion 1003, thereby selectively and reversibly securing the edible panel into the cutout portion 1003 by friction. In yet other cases, the retaining bumps 3001 can be configured and/or sized to indent into the edible panel without cracking or breaking the edible panel and/or the edible connector 10.

Although FIGS. 3A, 3B, 3C, and 3D illustrate retaining bumps 3001 as rounded hemispheres, the retaining bumps 3001 can comprise other shapes and/or configurations. For example, the retaining bumps 3001 can be shaped as one or more of ovals, ellipsoids, triangles, three-sided pyramids, four-sided pyramids, squares, hexagons, heptagons, octagons, and other similar shapes. Likewise, the retaining bumps 3001 can also comprise one or more of a squared, a rounded, a sloped, a beveled, and a tapered leading edge. Similarly, each cutout 1003 can comprise more than one retaining bump 3001. For example, a cutout portion 1003 can comprise 1, 2, 3, 4, 5, 6, 7, 8, 9, 10 or more retaining bumps 3001.

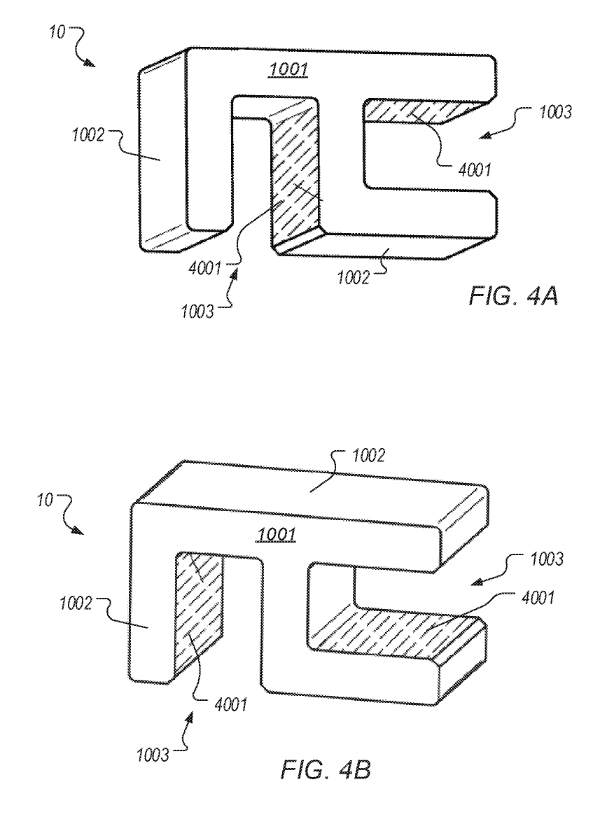

Referring now to FIGS. 4A and 4B, some embodiments of an edible connector 10 comprising features configured to selectively and reversibly secure and/or retain the edible panels are illustrated. FIGS. 4a and 4B show that at least in some embodiments, the edible connector 10 comprises one or more textured surfaces 4001 configured to selectively and reversibly secure and/or retain the edge of an edible panel once the edge has been inserted into the cutout portion 1003. Although the textured surfaces 4001 can be configured in any suitable manner, at least in some instances the textured surfaces 4001 can be configured as a pattern of grooves and lands. For example, the textured surface 4001 can be configured as a pattern of grooves and lands on the parallel channel wall 1005a, 1005b. In some cases, the textured surface 4001 can be configured to indent into, at least in part, the edible panel once the edge of the edible panel is inserted into the cutout portion 1003, thereby selectively and reversibly securing the edible panel into the cutout portion 1003 and avoiding disengagement of the edible panel from the edible connector 10. In other cases, the textured surface 4001 can be configured to indent into, at least in part, the edible panel once the edge of the edible panel is inserted into the cutout portion 1003, thereby selectively and reversibly securing the edible panel into the cutout portion 1003 by friction. In yet other cases, the textured surface 4001 can be configured and/or sized to indent into the edible panel without cracking or breaking the edible panel and/or the edible connector 10.

Although FIGS. 4a and 4B illustrate textured surface 4001 as a pattern of grooves and lands, the textured surface 4001 can comprise other shapes and/or configurations. For example, the textured surface 4001 can be shaped as a crisscross pattern, a triangular pattern, a circular pattern, an oval pattern, a cross-hatched pattern, a radial pattern, an isotropic pattern, or any other similar pattern.

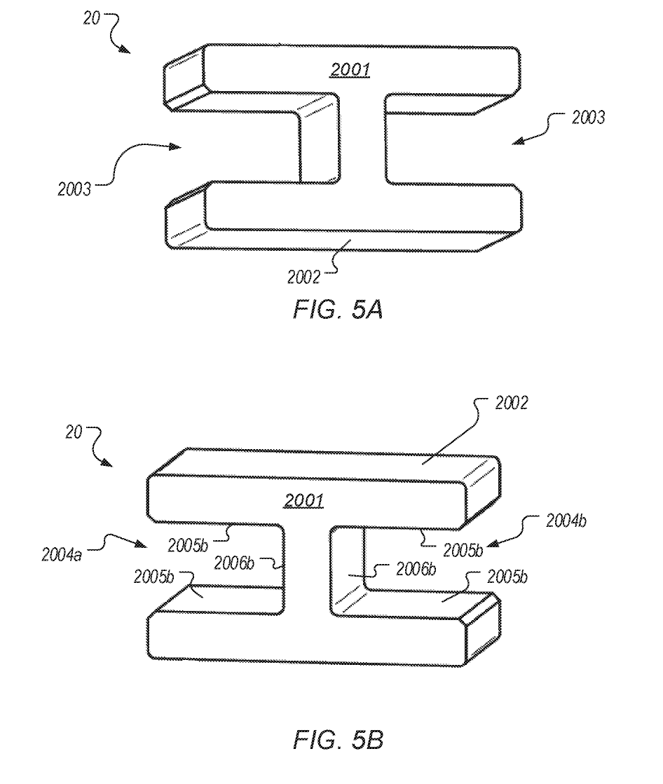

Referring now to FIGS. 5A and 5B, some embodiments of an edible connector 20 are illustrated. FIG. 5A shows that at least in some embodiments, the edible connector 20 comprises a body 2001. The body 2001 can comprise an outer surface 2002. The outer surface 2002 of the body 2001 can be rounded, chamfered, and/or squared. Likewise, the outer surface 2002 can be textured to facilitate gripping and/or manipulation of the edible connector 20 by a user. Additionally, the body 2001 can be configured to be sized to gripped and/or manipulated by the user. For example, the body 2001 can be configured to be sized to be gripped and/or manipulated by a thumb and forefinger of the user. In some instances, the body 2001 is configured as a rectangular block comprising one or more of a length, a width, and a height.

As described above, the body 2001 can be configured with one or more cutout portions 2003. In some embodiments, the cutout portions 2003 are configured to selectively and reversibly receive one or more edges of an edible panel. For example, the cutout portions 2003 can be configured as slots, channels, openings, grooves, canals, depressions, and/or other similar mechanical features. As shown in FIG. 5B, the cutout portions 2003 can comprise a first slot 2004a and a second slot 2004b. The first slot 2004a and the second slot 2004b can be configured in any fashion with respect to each other. For example, the first slot 2004a and the second slot 2004b can be configured such that the slots are coplanar and arranged in parallel (e.g., at an 180° angle). In some instances, the first slot 2004a and the second slot 2004b can be configured such that the slots are coplanar and arranged at an angle of approximately 180° to provide an 180° connection between edible panels.

The first slot 2004a can comprise parallel channel walls 2005a oriented in perpendicular fashion to a channel floor 2006a. The second slot 2004b can likewise comprise parallel channel walls 2005b oriented in a perpendicular fashion to a channel floor 2006b. In some cases, the cutout portions 2003 can be configured with one or more of chamfering, rounding, squaring, and texture. For example, FIG. 5B illustrates the first slot 2004a and the second slot 2004b comprising rounding as the channel walls 2005a, 2005b join with the outer surface 2002. Likewise, the first slot 2004a and the second slot 2004b can comprising rounding as the channel walls 2005a, 2005b join with the channel floor 2006a, 2006b. In some instances, the first slot 2004a and the second slot 2004b can be configured to selectively and reversibly secure an edible panel by a friction fitting.

Additionally, in some embodiments, the cutout portions 2003 comprise features configured to selectively and reversibly secure and/or retain the edible panels. For example, the cutout portions 2003 can comprise one or more of friction fittings, grips, gripping teeth, ridges, fins, bumps, texturing, pins, and other similar features. In some embodiments, the cutout portions 2003 comprise one or more retaining ridges configured to selectively and reversibly secure and/or retain the edge of an edible panel once the edge has been inserted into the cutout portion 2003. In other embodiments, the edible connector 20 comprises one or more retaining bumps configured to selectively and reversibly secure and/or retain the edge of an edible panel once the edge has been inserted into the cutout portion 2003. In yet other embodiments, the edible connector 20 comprises one or more textured surfaces configured to selectively and reversibly secure and/or retain the edge of an edible panel once the edge has been inserted into the cutout portion 2003.

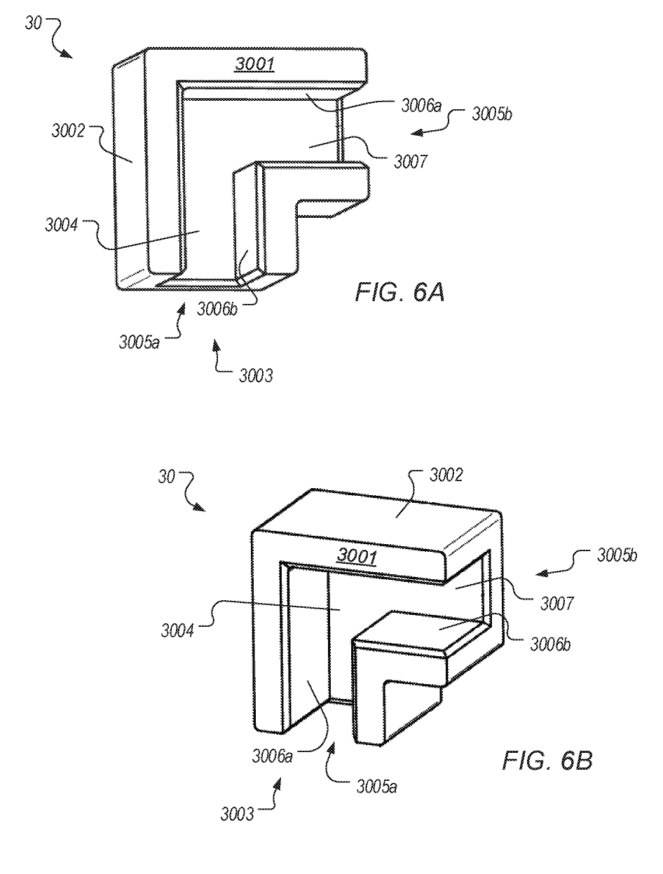

Referring now to FIGS. 6A and 6B, some embodiments of an edible connector 30 are illustrated. FIGS. 6A and 6B show that at least in some embodiments, the edible connector 30 comprises a body 3001. The body 3001 can comprise an outer surface 3002. The outer surface 3002 of the body 3001 can be rounded, chamfered, and/or squared. Likewise, the outer surface 3002 can be textured to facilitate gripping and/or manipulation of the edible connector 30 by a user. Additionally, the body 3001 can be configured to be sized to gripped and/or manipulated by the user. For example, the body 3001 can be configured to be sized to be gripped and/or manipulated by a thumb and forefinger of the user.

As described above, the body 3001 can be configured with a cutout portion 3003. In some embodiments, the cutout portion 3003 is configured to selectively and reversibly receive one or more edges of an edible panel. For example, the cutout portion 3003 can be configured as a slot, a channel, an opening, a groove, a canal, a depression, and/or any other similar mechanical feature. As shown in FIGS. 6A and 6B, the cutout portion 3003 can comprise a channel 3004. The channel 3004 can extend between a first opening 3005a and a second opening 3005b. The first opening 3005a and the second opening 3005b can be configured in any fashion with respect to each other. For example, the first opening 3005a and the second opening 3005b can be configured such that the openings are arranged at an about 90° angle. In some instances, the first opening 3005a and the second opening 3005b can be configured such that the openings are arranged at an about 90° angle to provide an 90° connection between edible panels.

In some cases, the channel 3004 can comprise parallel channel walls 3006a and 3006b oriented in perpendicular fashion to a channel floor 3007. In other cases, the cutout portion 3003 can be configured with one or more of chamfering, rounding, squaring, and texture. For example, FIGS. 6A and 6B illustrate that the channel 3004 can comprise rounding as the channel walls 3006a, 3006b join with the outer surface 3002. In yet other cases, the first opening 3005a and the second opening 3005b can be configured to selectively and reversibly secure an edible panel by a friction fitting.

Additionally, in some embodiments, the cutout portion 3003 comprises features configured to selectively and reversibly secure and/or retain the edible panels. For example, the cutout portion 3003 can comprise one or more of friction fittings, grips, gripping teeth, ridges, fins, bumps, texturing, pins, and other similar features. In other embodiments, the cutout portion 3003 comprises one or more retaining ridges configured to selectively and reversibly secure and/or retain the edge of an edible panel once the edge has been inserted into the cutout portion 3003. In other embodiments, the edible connector 30 comprises one or more retaining bumps configured to selectively and reversibly secure and/or retain the edge of an edible panel once the edge has been inserted into the cutout portion 3003. In yet other embodiments, the edible connector 30 comprises one or more textured surfaces configured to selectively and reversibly secure and/or retain the edge of an edible panel once the edge has been inserted into the cutout portion 3003.

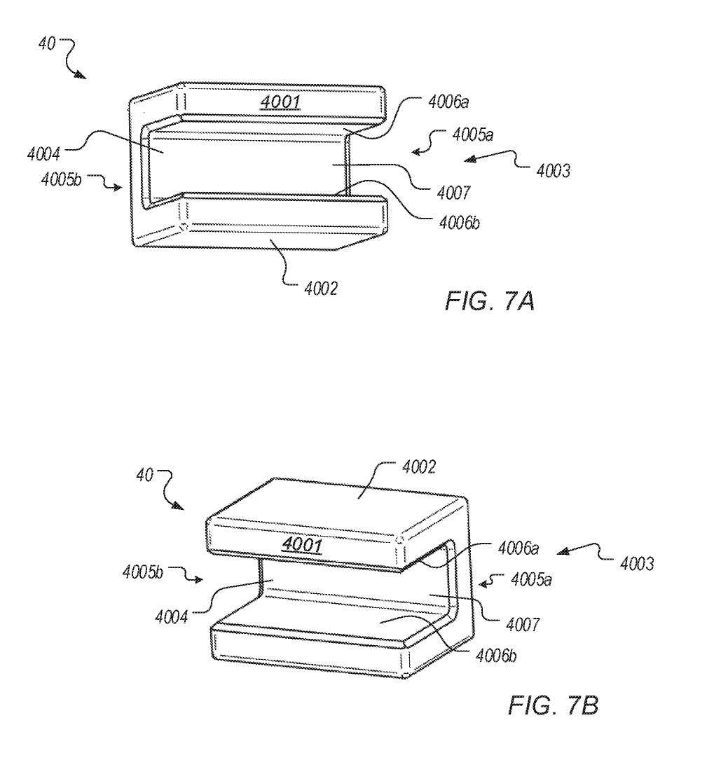

Referring now to FIGS. 7A and 7B, some embodiments of an edible connector 40 are illustrated. FIGS. 7A and 7B show that at least in some embodiment, the edible connector 40 comprises a body 4001. The body 4001 can comprise an outer surface 4002. The outer surface 4002 of the body 4001 can be rounded, chamfered, and/or squared. Likewise, the outer surface 4002 can be textured to facilitate gripping and/or manipulation of the edible connector 40 by a user. Additionally, the body 4001 can be configured to be sized to gripped and/or manipulated by the user. For example, the body 4001 can be configured to be sized to be gripped and/or manipulated by a thumb and forefinger of the user.

As described above, the body 4001 can be configured with a cutout portion 4003. In some embodiments, the cutout portion 4003 is configured to selectively and reversibly receive one or more edges of an edible panel. For example, the cutout portion 4003 can be configured as a slot, a channel, an opening, a groove, a canal, a depression, and/or any other similar mechanical feature. As shown in FIGS. 7A and 7B, the cutout portion 4003 can comprise a channel 4004. The channel 4004 can extend between a first opening 4005a and a second opening 4005b. The first opening 4005a and the second opening 4005b can be configured in any fashion with respect to each other. For example, the first opening 4005a and the second opening 4005b can be configured such that the openings are arranged at an about 180° angle (e.g., in a straight line). In some instances, the first opening 4005a and the second opening 4005b can be configured such that the openings are arranged at an about 180° angle to provide a selective and detachable 180° connection between edible panels.

In some cases, the channel 4004 can comprise parallel channel walls 4006a and 4006b oriented in perpendicular fashion to a channel floor 4007. In other cases, the cutout portion 4003 can be configured with one or more of chamfering, rounding, squaring, and texture. For example, FIGS. 7A and 7B illustrate that the channel 4004 can comprise rounding as the channel walls 4006a, 4006b join with the outer surface 4002. In yet other cases, one or more of the channel 4004, the first opening 4005a, the second opening 4005b, the channel walls 4006a, 4006b, and the channel floor 4007 can be configured to selectively and reversibly secure an edible panel by a friction fitting.

Additionally, in some embodiments, the cutout portion 4003 comprises features configured to selectively and reversibly secure and/or retain the edible panels. For example, the cutout portion 4003 can comprise one or more of friction fittings, grips, gripping teeth, ridges, fins, bumps, texturing, pins, and other similar features. In other embodiments, the cutout portion 4003 comprises one or more retaining ridges configured to selectively and reversibly secure and/or retain the edge of an edible panel once the edge has been inserted into the cutout portion 4003. In other embodiments, the edible connector 40 comprises one or more retaining bumps configured to selectively and reversibly secure and/or retain the edge of an edible panel once the edge has been inserted into the cutout portion 4003. In yet other embodiments, the edible connector 40 comprises one or more textured surfaces configured to selectively and reversibly secure and/or retain the edge of an edible panel once the edge has been inserted into the cutout portion 4003.

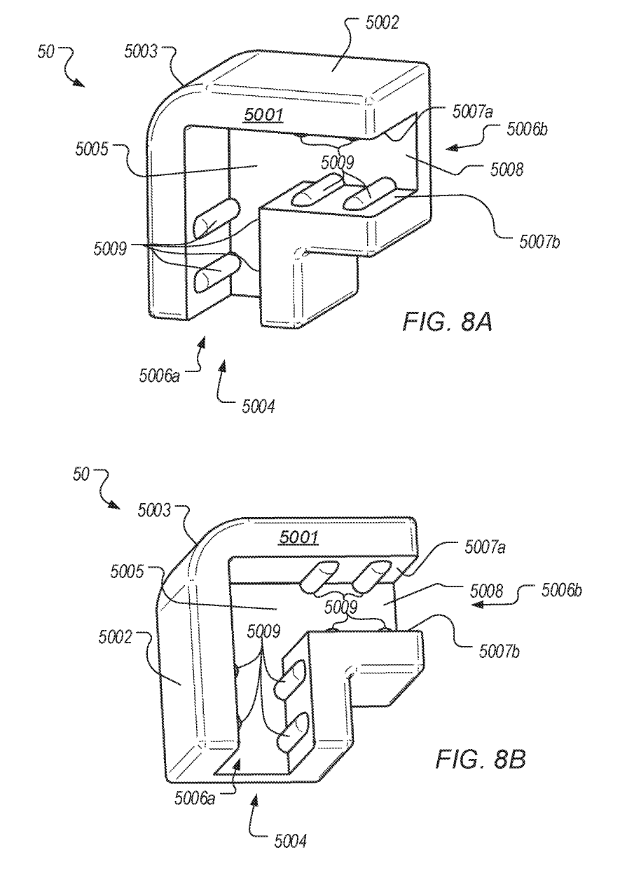

Referring now to FIGS. 8A and 8B, some embodiments of an edible connector 50 are illustrated. FIGS. 8A and 8B show that at least in some embodiments, the edible connector 50 comprises a body 5001. The body 5001 can comprise an outer surface 5002. The outer surface 5002 of the body 5001 can be rounded, chamfered, and/or squared. For example, the outer surface 5002 can comprise a chamfered corner 5003. Likewise, the outer surface 5002 can be textured to facilitate gripping and/or manipulation of the edible connector 50 by a user. Additionally, the body 5001 can be configured to be sized to gripped and/or manipulated by the user. For example, the body 5001 can be configured to be sized to be gripped and/or manipulated by a thumb and forefinger of the user.

As described above, the body 5001 can be configured with a cutout portion 5004. In some embodiments, the cutout portion 5004 is configured to selectively and reversibly receive one or more edges of an edible panel. For example, the cutout portion 5004 can be configured as a slot, a channel, an opening, a groove, a canal, a depression, and/or any other similar mechanical feature. As shown in FIGS. 8A and 8B, the cutout portion 5004 can comprise a channel 5005. The channel 5005 can extend between a first opening 5006a and a second opening 5006b. The first opening 5006a and the second opening 5006b can be configured in any fashion with respect to each other. For example, the first opening 5006a and the second opening 5006b can be configured such that the openings are arranged at an about 90° angle. In some instances, the first opening 5006a and the second opening 5006b can be configured such that the openings are arranged at an about 90° angle to provide an 90° connection between edible panels.

In some cases, the channel 5005 can comprise parallel channel walls 5007a and 5007b oriented in perpendicular fashion to a channel floor 5008. In other cases, the first opening 5006a and the second opening 5006b can be configured to selectively and reversibly secure an edible panel by a friction fitting. Additionally, in some embodiments, the cutout portion 5004 comprises features configured to selectively and reversibly secure and/or retain the edible panels. For example, the cutout portion 5004 can comprise one or more of friction fittings, grips, gripping teeth, ridges, fins, bumps, texturing, pins, and other similar features. In other embodiments, the cutout portion 5004 comprises one or more retaining ridges 5009 configured to selectively and reversibly secure and/or retain the edge of an edible panel once the edge has been inserted into the cutout portion 5004. The retaining ridges 5009 can be configured to rise from the channel floor 5008 and to be disposed along the channel walls 5007a and 5007b. In some cases, each opening 5006a, 5006b comprises two pairs of retaining ridges 5009. The first pair of retaining ridges 5009 can be disposed on the channel wall 5007a and the second pair of retaining ridges 5009 can be disposed on the channel wall 5007b. In other cases, the retaining ridges 5009 can be rounded and/or chamfered to facilitate insertion of an edge of an edible panel into the cutout portion 5004. In some instances, the retaining ridges 5009 can be configured to indent into, at least in part, the edible panel once the edge of the edible panel is inserted into the cutout portion 5004, thereby selectively and reversibly securing the edible panel into the cutout portion 5004 by friction. In other instances, the retaining ridges 5009 can be configured and/or sized to indent into the edible panel without cracking or breaking the edible panel and/or the edible connector 50.

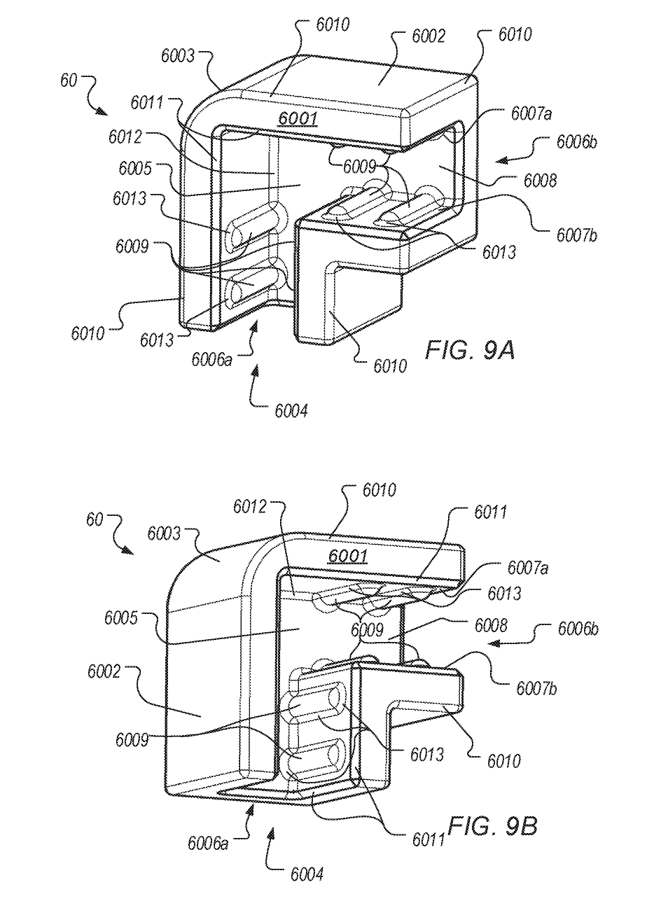

Referring now to FIGS. 9A and 9B, some embodiments of an edible connector 60 are illustrated. FIGS. 9A and 9B show that at least in some embodiments, the edible connector 60 comprises a body 6001. The body 6001 can comprise an outer surface 6002. The outer surface 6002 of the body 6001 can be rounded, chamfered, and/or squared. For example, the outer surface 6002 can comprise a chamfered corner 6003. Likewise, the outer surface 6002 can be textured to facilitate gripping and/or manipulation of the edible connector 60 by a user. Additionally, the body 6001 can be configured to be sized to gripped and/or manipulated by the user. For example, the body 6001 can be configured to be sized to be gripped and/or manipulated by a thumb and forefinger of the user.

As described above, the body 6001 can be configured with a cutout portion 6004. In some embodiments, the cutout portion 6004 is configured to selectively and reversibly receive one or more edges of an edible panel. For example, the cutout portion 6004 can be configured as a slot, a channel, an opening, a groove, a canal, a depression, and/or any other similar mechanical feature. As shown in FIGS. 9A and 9B, the cutout portion 6004 can comprise a channel 6005. The channel 6005 can extend between a first opening 6006a and a second opening 6006b. The first opening 6006a and the second opening 6006b can be configured in any fashion with respect to each other. For example, the first opening 6006a and the second opening 6006b can be configured such that the openings are arranged at an about 90° angle. In some instances, the first opening 6006a and the second opening 6006b can be configured such that the openings are arranged at an about 90° angle to provide an 90° connection between edible panels.

In some cases, the channel 6005 can comprise parallel channel walls 6007a and 6007b oriented in perpendicular fashion to a channel floor 6008. In other cases, the first opening 6006a and the second opening 6006b can be configured to selectively and reversibly secure an edible panel by a friction fitting. Additionally, in some embodiments, the cutout portion 6004 comprises features configured to selectively and reversibly secure and/or retain the edible panels. For example, the cutout portion 6004 can comprise one or more of friction fittings, grips, gripping teeth, ridges, fins, bumps, texturing, pins, and other similar features.

In some embodiments, the cutout portion 6004 comprises one or more retaining ridges 6009 configured to selectively and reversibly secure and/or retain the edge of an edible panel once the edge has been inserted into the cutout portion 6004. The retaining ridges 6009 can be configured to rise from the channel floor 6008 and to be disposed along the channel walls 6007a and 6007b. In some cases, each opening 6006a, 6006b comprises two pairs of retaining ridges 6009. The first pair of retaining ridges 6009 can be disposed on the channel wall 6007a and the second pair of retaining ridges 6009 can be disposed on the channel wall 6007b. In other cases, the retaining ridges 6009 can be rounded and/or chamfered to facilitate insertion of an edge of an edible panel into the cutout portion 6004. In some instances, the retaining ridges 6009 can be configured to indent into, at least in part, the edible panel once the edge of the edible panel is inserted into the cutout portion 6004, thereby selectively and reversibly securing the edible panel into the cutout portion 6004 by friction. In other instances, the retaining ridges 6009 can be configured and/or sized to indent into the edible panel without cracking or breaking the edible panel and/or the edible connector 60.

In some instances, the edible connector 60 comprises chamfered edges. In other instances, the edible connector 60 comprises chamfered edges configured for one or more of improving selective and reversible insertion of an edge of the edible panel into the edible cutout portion 6004, improving manipulation of the edible connector 60 by the user, improving visual appearance of the edible connector 60, and enhancing the ability to manufacture the edible connector 60 by molding techniques. For example, the edible connector 60 can comprise a chamfered edge 6010 along the body 6001. The edible connector 60 can also comprise a chamfered edge 6011 where the channel walls 6007a, 6007b meet the body 6001. Likewise, the edible connector 60 can comprise a chamfered edge 6012 where the channel walls 6007a, 6007b meet the channel floor 6008. Similarly, the edible connector can comprise chamfered edges 6013 where the retaining ridges 6009 meet the channel walls 6007a, 6007b and/or the channel floor 6008.

Methods of Use

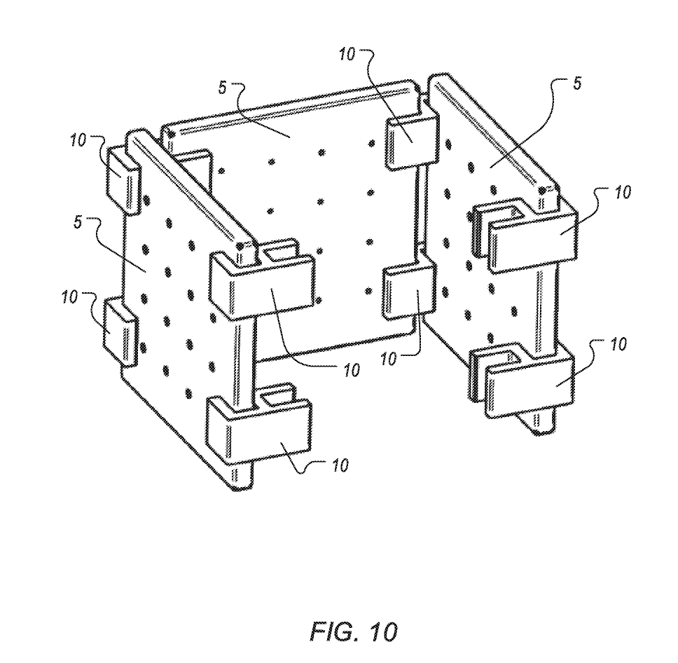

Referring now to FIGS. 10, 11, 12, and 13, views of edible connectors 10, 20, 30, 40 selectively and reversibly connected to edible panels 5 are illustrated. In some embodiments, one or more of edible connectors 10, 20, 30, 40 and edible panels 5 comprise edible building systems. The edible building systems can comprise any variety of edible connectors 10, 20, 30, 40 and edible panels 5 and can be configured to construct gingerbread-style houses. For example, edible connectors 20 and/or 40 can be used to form larger edible panels for one or more of walls, roof, and floor. These larger panels can then be interconnected with edible connectors 10 and/or 30 to construct gingerbread-style houses.

FIG. 10 shows that, at least in some embodiments, edible connectors 10 can be used to selectively and reversibly interconnect edible panels 5 at 90° angles. For example, an edge of a first edible panel 5 can be inserted into the first slot 1004a and an edge of a second edible panel 5 can be inserted into the second slot 1004b thereby interconnecting two edible panels 5 at about a 90° angle. As an edge of the first and/or second edible panel 5 is secured into the first and/or second slots 1004a, 1004b, the edge can be secured into the cutout portion 1003 by a friction fit formed by one or more of friction fittings, grips, gripping teeth, ridges, fins, bumps, texturing, pins, and other similar features. For example, the edge can be secured into the cutout portion 1003 by a friction fit formed by one or more of retaining ridges 2001, retaining bumps 3001, textured surfaces 4001, retaining ridges 5009, and retaining ridges 6009. Additional edible connectors 10 can be used to reinforce the connection between the two edible panels 5. Likewise, additional edible connectors 10 can be used to interconnect additional edible panels 5 to one or both of the first edible panels 5. Similarly, a combination of edible connectors 10 and edible panels 5 can be connected to create one or more of walls, roof, and floor for a gingerbread-style house.

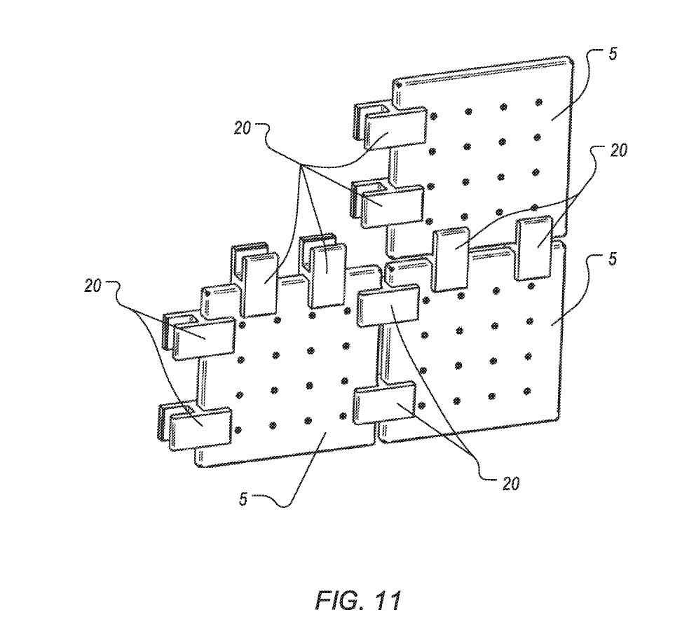

Referring now to FIG. 11, FIG. 11 shows that, at least in some embodiments, edible connectors 20 can be used to selectively and reversibly interconnect edible panels 5 as a straight line (e.g., at 180° angles). For example, an edge of a first edible panel 5 can be inserted into the first slot 2004a and an edge of a second edible panel 5 can be inserted into the second slot 2004b thereby interconnecting two edible panels 5 at about a 180° angle. As an edge of the first and/or second edible panel 5 is secured into the first and/or second slots 2004a, 2004b, the edge can be secured into the cutout portion 2003 by a friction fit formed by one or more of friction fittings, grips, gripping teeth, ridges, fins, bumps, texturing, pins, and other similar features. Additional edible connectors 20 can be used to reinforce the connection between the two edible panels 5. Likewise, additional edible connectors 20 can be used to interconnect additional edible panels 5 to one or both of the first edible panels 5. Similarly, a combination of edible connectors 20 and edible panels 5 can be connected to create one or more of walls, roof, and floor for a gingerbread-style house. Additionally, a combination of edible connectors 20 and edible panels 5 can be connected to create larger edible panels to form one or more of walls, roof, and floor for a gingerbread-style house.

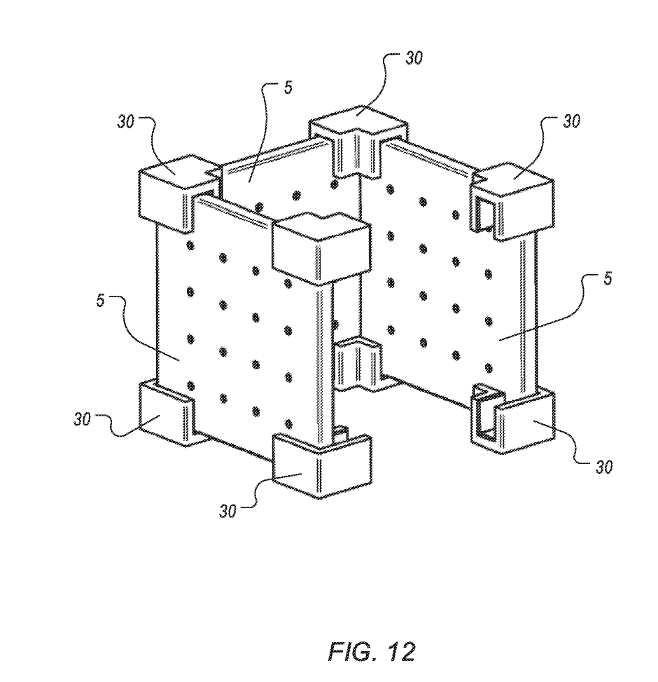

Referring now to FIG. 12, FIG. 12 shows that, at least in some embodiments, edible connectors 30 can be used to selectively and reversibly interconnect edible panels 5 at 90° angles. For example, an edge of a first edible panel 5 can be inserted into the first slot 3005a and an edge of a second edible panel 5 can be inserted into the second slot 3005b thereby interconnecting two edible panels 5 at about a 90° angle. As an edge of the first and/or second edible panel 5 is secured into the first and/or second slots 3005a, 3005b, the edge can be secured into the cutout portion 3003 by a friction fit formed by one or more of friction fittings, grips, gripping teeth, ridges, fins, bumps, texturing, pins, and other similar features. Additional edible connectors 30 can be used to reinforce the connection between the two edible panels 5. Likewise, additional edible connectors 30 can be used to interconnect additional edible panels 5 to one or both of the first edible panels 5. Similarly, a combination of edible connectors 30 and edible panels 5 can be connected to create one or more of walls, roof, and floor for a gingerbread-style house.

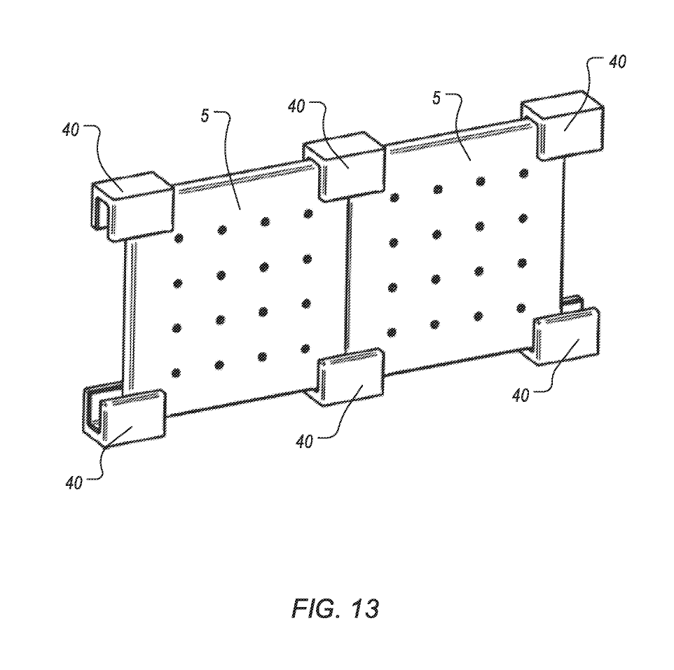

Referring now to FIG. 13, FIG. 13 shows that, at least in some embodiments, edible connectors 40 can be used to selectively and reversibly interconnect edible panels 5 as a straight line (e.g., at 180° angles). For example, an edge of a first edible panel 5 can be inserted into the first slot 4005a and an edge of a second edible panel 5 can be inserted into the second slot 4005b thereby interconnecting two edible panels 5 at about a 180° angle. As an edge of the first and/or second edible panel 5 is secured into the first and/or second slots 4005a, 4005b, the edge can be secured into the cutout portion 4003 by a friction fit formed by one or more of friction fittings, grips, gripping teeth, ridges, fins, bumps, texturing, pins, and other similar features. Additional edible connectors 40 can be used to reinforce the connection between the two edible panels 5. Likewise, additional edible connectors 40 can be used to interconnect additional edible panels 5 to one or both of the first edible panels 5. Similarly, a combination of edible connectors 40 and edible panels 5 can be connected to create one or more of walls, roof, and floor for a gingerbread-style house. Additionally, a combination of edible connectors 40 and edible panels 5 can be connected to create larger edible panels to form one or more of walls, roof, and floor for a gingerbread-style house.

Methods of Manufacture

While the described edible connectors can be manufactured in any suitable manner, at least in some embodiments, the edible connectors are manufactured from hard candy using techniques known in the art. For example, the edible connectors can be manufactured from hard candy using food safe molds and known hard candy molding techniques, including techniques utilizing food safe injection molding machines (e.g., the food safe injection molding machines manufactured by the Allforge Company). The mold negatives and positives can be manufactured using standard machining techniques and/or 3D printing techniques. In some cases, the edible connectors can be manufactured directly by 3D printing (e.g., printing on a Magic Candy Factory 3D printer).

Although the described edible connectors can comprise any suitable edible material, at least in some embodiments, the edible connectors comprise a confection comprising sugar as a principal ingredient (e.g., hard candy, soft candy, caramel, nougat, taffy, and/or toffee). In some cases, the edible connectors can comprise one or more of hard candy, soft candy, caramel, nougat, taffy, and toffee. In other cases, the edible connectors comprise hard candy prepared from a sugarbased syrup comprising sucrose, glucose, fructose, and/or other sugars. The hard candy can be prepared by preparing a sugar-based syrup, heating the syrup to a pre-determined temperature, and adding additional ingredients such as citric acid, food coloring, flavoring, extracts, and essential oils. The hot, liquid hard candy can then be molded to produce the edible connectors. In some cases, the hard candy is prepared as a sugar glass candy by preparing a sugar-based syrup and heating the sugar-based syrup to hard crack stage (e.g., between 146° C. and 154° C.). The hot sugar glass candy is then molded to form the edible connectors.

### Example 1

An edible connector was prepared according to the embodiments indicated in FIGS. 1A, 1B, and 1C. The body comprised an approximate length of 21.52 mm, an approximate width of 11.85 mm, and an approximate height of 12.35 mm. The openings of the first and second slots were approximately 5 mm wide and the depths of the slots were approximately 9.18 mm. The first and second slots were oriented at an angle of approximately 90° with respect to each other.

### Example 2

An edible connector was prepared according to the embodiments indicated in FIGS. 2A, 2B, 2C, and 2D. The body comprised an approximate length of 21.52 mm, an approximate width of 11.85 mm, and an approximate height of 12.35 mm. The openings of the first and second slots were approximately 6 mm wide and the depths of the slots were approximately 9.18 mm. The first and second slots were oriented at an angle of approximately 90° with respect to each other. Additionally, the first and second slots each comprised a single retaining ridge extending into the slot about 1.6 mm and having a width of about 0.5 mm.

### Example 3

An edible connector was prepared according to the embodiments indicated in FIGS. 3A, 3B, 3C, and 3D. The body comprised an approximate length of 21.52 mm, an approximate width of 11.85 mm, and an approximate height of 12.35 mm. The openings of the first and second slots were approximately 6 mm wide and the depths of the slots were approximately 9.18 mm. The first and second slots were oriented at an angle of approximately 90° with respect to each other. Additionally, the first and second slots each comprised a set of four retaining bumps extending into the slot and having a radius of about 0.8 mm.

The edible building systems and edible connectors described herein can have several useful features. First, the edible connectors allows the user to easily and quickly interconnect edible panels to form a gingerbread-style house without adhesive. Additionally, eliminating the need for adhesives such as royal icing reduces mess and permits faster build times. Likewise, eliminating the need for adhesives such as hot glue eliminates the risk of burns or damage from hot glue. Moreover, the edible connectors form an integral part of the completed gingerbread-style house and do not need to be removed and can be eaten with the rest of the edible gingerbread-style house. Furthermore, the edible connectors can be used with varying thickness of edible panels and can be used with edible panels produced by a variety of manufacturers. The edible connectors can also be manufactured as a single piece, thereby reducing complexity and manufacturing costs, and increasing reliability. Finally, the edible connectors can be used to interconnect edible panels at predefined useful angles (e.g., 90° and 180°).

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. An edible connector configured to interconnect edible panels for the construction of gingerbread-style houses, the edible connector comprising:
a body comprising an edible material; and
a cutout portion disposed on the body, wherein the cutout portion is configured to receive and secure an edge of an edible panel.

2. The edible connector of claim 1, wherein the cutout portion comprises a first slot.

3. The edible connector of claim 2, wherein the first slot comprises a channel floor and channel walls.

4. The edible connector of claim 2, wherein the cutout portion comprises a second slot.

5. The edible connector of claim 4, wherein the second slot comprises a channel floor and channel walls.

6. The edible connector of claim 5, wherein the first slot is oriented at 90° with respect to the second slot.

7. The edible connector of claim 5, wherein the first slot is oriented at 180° with respect to the second slot.

8. The edible connector of claim 1, wherein the edible connector comprises a hard candy.

9. The edible connector of claim 8, wherein the hard candy comprises a sugar glass candy prepared by heating a sugar-based syrup to between about 146° C. and 154° C. to achieve a hard crack stage.

10. The edible connector of claim 1, wherein the cutout portion further comprises one or more of a retaining ridge, a retaining bump, and a texturing configured to retain the edge of the edible panel.

11-12. (canceled)

13. An edible building system for constructing gingerbread-style houses, the system comprising:
edible connectors comprising a body with a cutout portion, the cutout portion configured to receive and secure an edge of an edible panel; and
edible panels,
wherein the edible connectors are configured to interconnect the edible panels to construct a gingerbread-style house.

14. The edible building system of claim 13, wherein the cutout portion further comprises a first slot and a second slot.

15. The edible building system of claim 14, wherein the first slot is oriented at 90° with respect to the second slot.

16. The edible building system of claim 14, wherein the first slot is oriented at 180° with respect to the second slot.

17. The edible building system of claim 13, wherein the edible connectors comprise a hard candy.

18. The edible building system of claim 13, wherein the cutout portion further comprises one or more of a retaining ridge, a retaining bump, and a texturing configured to retain the edge of the edible panel.

19-20. (canceled)

21. A method of manufacturing an edible connector configured to interconnect edible panels for the construction of gingerbread-style houses, the method comprising:
providing a mold to form an edible connector comprising a body with a cutout portion disposed on the body, wherein the cutout portion is configured to receive and secure an edge of an edible panel;
preparing a hard candy comprising a sugar glass candy prepared by heating a sugar-based syrup to between about 146° C. and 154° C. to achieve a hard crack stage; and
molding the prepared hard candy with the mold.

22. The method of claim 21, wherein the cutout portion further comprises a first slot and a second slot.

23. The method of claim 22, wherein the first slot is oriented at 90° with respect to the second slot.

24. The method of claim 22, wherein the first slot is oriented at 180° with respect to the second slot.

25-27. (canceled)
